(19) United States
(12) Patent Application Publication
(10) Pub. No.: US 2017/0108612 A1
(43) Pub. Date: Apr. 20, 2017

(54) INERTIAL SYSTEM FOR GRAVITY DIFFERENCE MEASUREMENT

(71) Applicant: KING SAUD UNIVERSITY, RIYADH (SA)

(72) Inventors: AYMAN S. HASSAN AGUIB, CAIRO (EG); AHMED HASSAN MOHAMED, GAINESVILLE, FL (US)

(21) Appl. No.: 14/883,968

(22) Filed: Oct. 15, 2015

(51) Int. Cl. G01V 7/06; G01V 7/16

(52) U.S. Cl. CPC G01V 7/06; G01V 7/16

(57) ABSTRACT

The inertial system for gravity difference measurement uses COTS nano accelerometer and a strapdown Global Navigation Satellite System (GNSS)-aided inertial measurement unit (IMU). The former has low measurement noise density, while the latter is used to analytically stabilize the platform. Stochastic modeling of the gravity anomaly is utilized (as opposed to the deterministic modeling of causes and effects) to simplify the algorithm. The algorithm aims at finding relative changes between points, as opposed to absolute values at the points, which allows for high relative precision required in many applications.

### BACKGROUND OF THE INVENTION

1. Field of the Invention

The present invention relates to airborne gravimetry, and particularly to an inertial system for gravity difference measurement that uses a global navigation satellite system (GNSS) in combination with a strapdown inertial measurement unit (IMU) on an airborne platform to measure differences in the earth's gravitational field.

2. Description of the Related Art

Airborne gravimetry technology using strap-down IMU/GPS methods has been heavily researched at the University of Calgary over a 10+ year period. More recently, IMU/GPS gravimetry research has also been conducted at Ohio State University.

All major airborne gravimeter solutions today use gimbaled systems to isolate the precision accelerometers from the attitude motion of the aircraft and require that the aircraft fly in light turbulence to achieve the necessary quiet environment for gravimetry sensing.

Generally, these traditional methods use extensions of the ground-based accelerometer methods and attempt to place the airborne sensors into a ground-like motion-isolated environment.

Conventional systems for gravity difference measurement use proprietary accelerometer designs built in-house that are usually bulky, expensive, and not easily upgradable.

Thus, an inertial system for gravity difference measurement solving the aforementioned problems is desired.

### SUMMARY OF THE INVENTION

The inertial system for gravity difference measurement uses commercial-off-the-shelf (COTS) nano accelerometers and strap-down Global Navigation Satellite System (GNSS)-aided inertial measurement units (IMU). The former has low measurement noise density, while the latter is used to analytically stabilize the platform. Stochastic modeling of the gravity anomaly is utilized (as opposed to the deterministic modeling of causes and effects) to simplify the algorithm. The algorithm aims at finding relative changes between points, as opposed to absolute values at the points, which allows for high relative precision required in many applications.

These and other features of the present invention will become readily apparent upon further review of the following specification and drawings.

### BRIEF DESCRIPTION OF THE DRAWINGS

FIG. 1 is a block diagram of an inertial system for gravity difference measurement according to the present invention.

FIG. 2 is a block diagram of power distribution for the inertial system for gravity difference measurement of FIG. 1.

FIG. 3 is a plot showing exemplary gravity disturbance covariance propagation for an inertial system for gravity difference measurement according to the present invention.

FIG. 4A is a block diagram showing the third-order Gauss-Markov gravity disturbance model (including a Kalman filter) used for the inertial system for gravity difference measurement of FIG. 1.

FIG. 4B is a waveform diagram showing how micro-gravity disturbances can be recovered from a low noise nano-accelerometer used for the inertial system for gravity difference measurement of FIG. 1.

FIG. 5 is a plot showing position error effects on gravity disturbance in Kalman gain for the inertial system for gravity difference measurement of FIG. 1.

FIG. 6 is a plot showing velocity error effects on gravity disturbance in Kalman gain for the inertial system for gravity difference measurement according to the present invention.

Similar reference characters denote corresponding features consistently throughout the attached drawings.

### DETAILED DESCRIPTION OF THE PREFERRED EMBODIMENTS

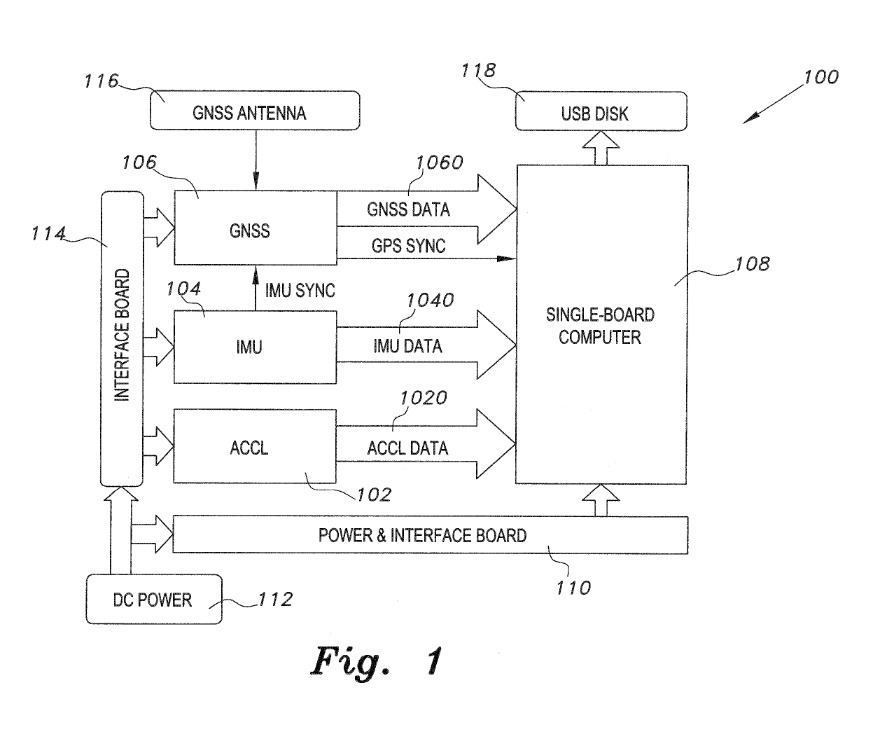

As shown in FIG. 1, the inertial system for gravity difference measurement (GravMap) 100 includes a GNSS receiver board 106 connected to a single-board computer 108. Inertial Measurement Unit (IMU) 104, and accelerometer 102 are also connected to the single-board computer 108. GNSS data 1060, IMU data 1040, and accelerometer data 1020 are exchanged between the GNSS 106, IMU 104 and accelerometer 102, respectively, and the single-board computer 108. The GNSS 106 also has a synchronization line connected to the computer 108. A GNSS antenna 116 is connected to the GNSS for reception of satellite global positioning data. Data processed by the computer 108 is stored on a USB disk or drive 118, which is connected to the computer 108.

A DC power source 112 is connected to a communal power and interface board 110, which connects to and powers the single board computer 108. The DC power source 112 is also connected to a second interface board 114, which is connected to and powers the GNSS 106, IMU 104 and accelerometer 102.

The IMU 104 and accelerometer 102 are housed separately from the system enclosure, but are connected to the single-board computer 108 via a communal cable. The IMU 104 is preferably a commercial-off-the-shelf (COTS) strap-down unit. The accelerometer 102 is preferably a COTS nano accelerometer. The connection of the GNSS antenna 116 to the GNSS 106, the connection of input DC power 112 to the interface boards 110, 114, and the connection of data storage 118 (a generic USB disk that also contains startup configuration scripts for the system) to the computer 108 are considered to be peripheral connections of the system 100. The COTS hardware is outlined in Table 1 (sensor head) and Table 2 (control box).

TABLE 1
Sensor Head Components

| Part | Manufacturer | Description | Part Number |
|---|---|---|---|
| GNSS | Antcom. | Active L1/L2 GNsSS | 3G1215A |
| Antenna | California | Antenna 3.5″ | |
| Accelerometer | Colibrys | three axis | SF3600.A |
| | Switzerland | combination of | |
| | | SF1600 Si-Flex ™ | |
| | | MEMS analog | |
| | | capacitive | |
| | | accelerometers | |
| IMU | Memsense, | H3 High Performance | HP02- |
| | South Dakota | 6 DOF IMU | 0150F050R |
| Enclosure | Geomatics | Custom 4″ × 4″ × 4″ | GravMap- |
| | USA, Florida | with mounting base, | SHE03 |
| | | DB15 and SMA | |
| | | communication | |
| | | interface and ACCEL | |
| | | and IMU LED | |
| | | indicators | |

TABLE 2
Control Box Components

| Part | Manufacturer | Description | Part Number |
|---|---|---|---|
| GNSS Board | Topcon, | EURO112T, Turbo | GGD- |
| | California | Board L1/L2, GPS, | EURO112T |
| | | GLONASS, RTK | |
| Single Board | Diamond | PC/104 SBC with | HELIOS |
| Computer | Systems, | Vortex Processor | HLV1000- |
| | California | and Integrated Data | 256AV |
| | | Acquisition | |
| Power Supply | YABO OEM, | Low-noise 12 V DC | YB- |
| | China | 6800 mAh | 1206800mah |
| | | rechargeable Lithium | |
| | | Battery | |
| Power and | Geomatics | Custom PCB to | GravMap- |
| Interface | USA, Florida | regulate power, | PIB02 |
| Board | | | |

The single-board computer 108 is equipped with a 1 GHz Vortex processor and 256 MB memory with Linux as the operating system. The single-board computer 108 also features multiple I/O peripherals, among which one RS-232 port, one RS-422 port, six analog channels, and one external trigger pin are utilized in the operation of acquiring data from the GNSS receiver board 106, the IMU 104, and the accelerometer 102. All data acquired are stored in the USB disk 118.

The GNSS receiver board 106 is configured to output GNSS data (L1 and L2 range measurements and navigation data from satellites in both Global Positioning System (GPS) and GLObal NAvigation Satellite System (GLONASS) systems) in Radio Technical Commission (RTCM)-3 format at 20 Hz to the RS-232 port with baud rate 115200 bps on the single-board computer 108. The GNSS receiver board 106 also outputs a pulsing signal at 1 Hz to the external trigger pin for generating timestamps for acquired data. Additionally, means are provided in which the GNSS receiver board 106 also receives a pulsing signal at 1 Hz from the IMU 104 through its event marker for the purpose of generating timestamps for the IMU data. In addition, there is a bi-color LED indicator from the GNSS receiver board 106 provided as means for indicating the number of satellites tracked by the receiver, wherein a number of green flashes indicates how many GPS satellites are tracked, and a number of yellow flashes indicates how many GLONASS satellites are tracked.

The IMU 104 features three gyros, three accelerometers, three magnetometers, and one temperature sensor. The IMU 104 outputs binary concatenated data packets at 150 Hz to the RS-422 port with a baud rate of 115200 bps. The IMU 104 enables hardware time-synchronization by outputting a 1 Hz pulsing signal to the event marker input pin of GNSS receiver board 106 and incorporating the status of a predefined data hit (one or zero) in its packet to reflect the status of the pulsing signal (high or low). The GNSS receiver board 106 then generates a timestamp upon the arrival of each pulse.

The accelerometer 102 is a three-axis accelerometer with ultra-low noise in order to detect the anomaly of gravity signal at the level of micro-G. The accelerometer 102 outputs bipolar analog signals to the analog I/O ports on single-board computer 108. The single-board computer 108 provides dedicated 16-bit analog-to-digital conversion circuitry, a hardware buffer (FIFO, first-in-first-out), and interrupt-based software operations to acquire analog data with high precision.

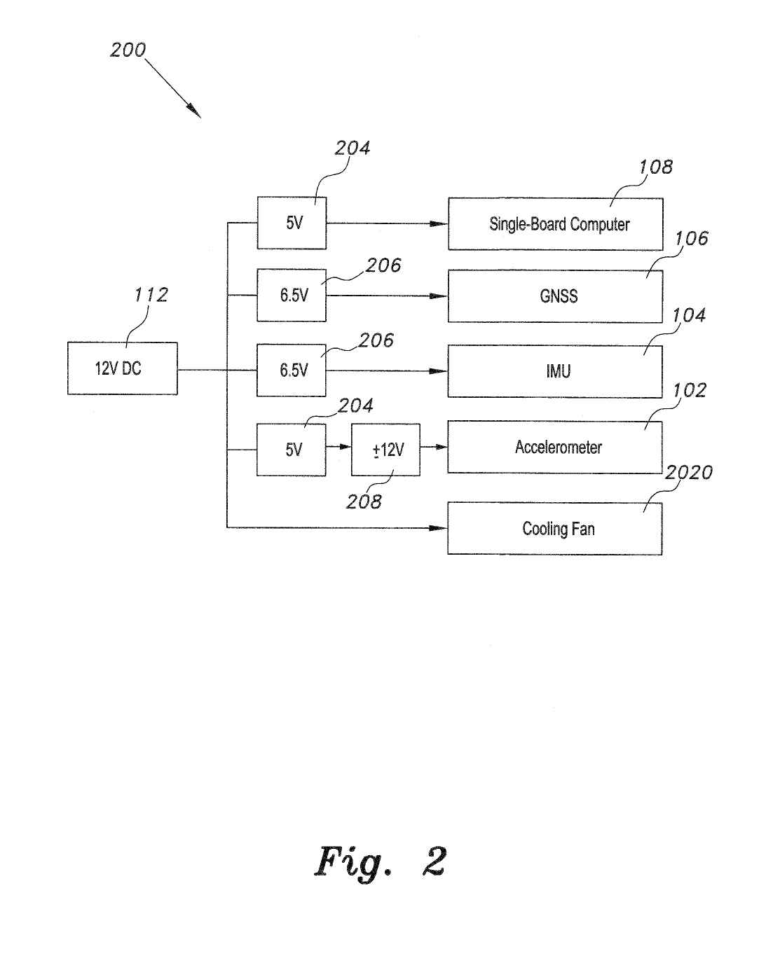

The power and interface board 110 provides necessary power supply circuitry for all components and connections among them. The main power supply input 112 is required to be 12V DC. The 12V DC power supply 112 and interface boards 114, 110 form a power distribution system 200 that regulates and distributes power to all the components, as shown in FIG. 2. The power distribution system 200 includes a first regulated 5-volt power source 204 connected to the single board computer 108 and a second regulated 5-volt power source 204 connected to a bipolar ±12-volt power source 208, which is connected to the accelerometer 102. First and second regulated 6.5-volt power sources are connected to the GNSS 106 and the IMU 104, respectively. Thermal regulation of the system is provided by a cooling fan 2020 connected to the 12-volt DC power source 112.

The firmware comprises the software program(s) running on the single-board computer 108 for acquiring data from the GNSS receiver board 106, the IMU 104, and the accelerometer 102, including the synchronization (time-stamping) mechanism of acquired data. Programs include an algorithm that utilizes single board computer 108 as a means to perform stochastic modeling of the gravity anomaly (as opposed to the deterministic modeling of causes and effects) to simplify the algorithm. The algorithm aims at finding relative changes between points as opposed to absolute values at the points which allows for high relative precision required in many applications. Table 3 shows the pseudocode of the key functions of the firmware.

TABLE 3
Firmware Functions

| | |
|---|---|
| STEP | Function |

/ * Main Function * /

{

| | |
|---|---|
| dscInt (m) ; | / / Initialize the Universal Driver library |
| dsc Init Board (...) ; | / / Initialize single-board computer |
| dscADSetSettings (... ) ; | / / Setup A/D parameters |
| counter = 0; | |
| dscuserInt (MyUserIntFunc); | Issue interrupt in “ instead ” mode |
| while (counter < recordTime ) { | /* Loop Timer */ |
| dscSleep(... ); } | |

| | |
|---|---|
| dscCancelOp( ); | / * Cancel Interrupt Operations * / |

| | |
|---|---|
| dscClearUserInterruptFunction ( ); | / * Uninstall Interrupt Functions */ |
| dscFree( ); | / * Clean-up * / |
| return 0 ; | |
| } | |
| void MyUserIntFunc( ) | / * External triggered interrupt * / |
| { | |
| c o u n t e r++; | |

| | |
|---|---|
| gettimeofday( ) ; | / * Retrieve current computer time * / |
| GNSSSync( ): | / * Sync current GNSS data timetag * / |

| | |
|---|---|
| IMUSync( ) | / * Sync current IMU data frame count * |

/

| | |
|---|---|
| Read ADScan( ): | / * Read current A/D conversion * / |

| | |
|---|---|
| CaptureGNSS( ); | / * Save all data to disk * / |

CaptureIMU( ) ;
CaptureACCL( );

}

After initialization, the main function installs an interrupt routine for acquiring data from the GNSS receiver board 106, the IMU 104, and the accelerometer 102. The interrupt routine is triggered externally by the 1 Hz pulsing signal from the GNSS receiver board 106. The firmware timestamps GNSS time, IMU frame count, and accelerometer data with computer time for further synchronization in post-processing. Then the firmware reads and saves all data from buffer to disk.

The post-processing software translates/converts the acquired data to readable format. The acquisition software saves data in binary format and keeps timestamps in computer time without actually performing synchronization between computer time, GNSS time, and IMU frame count in order to maintain high data rate in acquiring data. The processing software is then used to convert/translate binary data into readable format. The processing software contains the following functions shown in Table 4.

TABLE 4
Processing Software Functions

| Name | Function |
|---|---|
| ConvertGNSS | converts binary RTCM3 data to standard |
| | RINEX format |
| ConvertIMU | converts binary IMU data to TEXT file |
| | with pulsing information |
| ExtractEvent | extracts IMU pulsing information (i.e., |
| | GNSS event marker) in GNSS time from |
| | binary GNSS data |
| SyncIMUTime | time-stamping IMU data with GNSS time |
| | by searching and interpolating IMU |
| | pulsing information in GNSS time |

Accelerometer data is already saved in TEXT format and time-stamped with GNSS time. The output of the processing software is TEXT files that include GNSS range measurements in Receiver Independent Exchange (RINEX) format, IMU data time-stamped in GNSS time, and the accelerometer data time-stamped in GNSS time. In other words, at any given GNSS time, there are range values with the attitudes, which will be further processed to produce trajectory coordinates, along with the accelerometer data for recording gravity values.

The operation of the GravMap System includes the following steps, shown in Table 5.

TABLE 5
GravMap System Operations

| Step | Function |
|---|---|
| 1 | Before powering up the system, assure |
| | peripherals are all properly connected |
| | (GNSS antenna, IMU cable connector, |
| | accelerometer cable connector, input power |
| | jack). |
| 2 | Plug in a USB disk with starting scripts pre- |
| | loaded in specified folder. |
| 3 | Power up the system with a 12 V DC input |
| | power source. |
| 4 | Time-stamping IMU data with GNSS time |
| | by searching and interpolating IMU |
| | pulsing information in GNSS time |
| 5 | Data acquisition automatically starts 3 min |
| | after the system powering up (waiting period |
| | adjustable through startup script) |
| 6 | Data acquisition automatically stops after 24 |
| | hours of continuous operation (acquisition |
| | duration adjustable through startup script) |
| 7 | Data acquisition can also be terminated by |
| | disconnecting input power |

The processing operation can be done through the following steps shown in Table 6.

TABLE 6
Processing Operation

| Step | Function |
|---|---|
| 1 | Plug USB disk into a computer with |
| | Windows/Linux operating systems cable |
| | connector, input power jack). |
| 2 | Locate desired data and copy them to a folder |
| | on processing computer. The acquired data will |
| | be stored in folders' names with format: |
| | <YYYYMMDD>/TEST<XXX>, where |
| | <YYYYMMDD> refers |
| | to the date of acquisition and <XXX> ranges |
| | from 000 to 999 indicating different data sets |
| | collected on the same day. |
| 3 | Copy pre-compiled executables of processing |
| | software to the same folder. |
| 4 | Execute batch file “processGravMap.bat” if |
| | using Windows and execute script |
| | “processGravMap.sh” if using Linux. |
| 5 | There will be three folders generated: output, |
| | raw, and temp. The folder “output” contains |
| | processed GNSS data, IMU data, and |
| | accelerometer data, in TEXT format and time- |
| | stamped. The folder “raw” contains original |
| | acquired binary data and the folder “temp” |
| | contains intermediate by-products for |
| | debugging purposes. |

The startup waiting period (default is 3 min) and the operation duration (default is 24 hr) can be adjusted by using any TEXT editor to modify two numbers in the startup script “startgm.sh” inside the folder “scripts” on the USB disk as shown in Table 7.

TABLE 7
Startup Waiting
STEP

echo ″Waiting for sensors to be ready(sleep 3 min ) ″
echo””
# # change the waiting period here # #
sleep 180s
####################################
echo””
echo ″ Running GravMap Application . . .
## change the operation duration here ##
(/home/Helios/scripts/recordgm 86400) &
########################################

With respect to the stochastic modeling of the gravity anomaly, the basic model used in the inertial system for gravity difference measurement is as follows:

δg=fᵤ−aᵤ+E_{c}−γᵤ, (1)

where δg is the upward component of the gravity disturbance, measured in mGal (milli Galileo) where 1 mGal˜1 μg=10⁻⁵ m/s² and g is the average Earth's gravity acceleration (˜9.81 m/s²), fᵤ is the upward component of the specific force, measured by the accelerometer, aᵤ is the upward component of the vehicle acceleration, derived from measured GPS position, γᵤ is the upward component of the normal gravity vector at vehicle height, computed analytically using normal ellipsoidal model (e.g. WGS84), and E_{c} is the Eötvös correction due to Coriolis and centrifugal accelerations in the horizontal plane resulting from the relative motion of the vehicle with respect to the rotating Earth. The Eötvös correction is computed as follows:

$${E}_{c} = 2 {v}_{E} {ω}_{e} cos ϕ + \frac{{v}_{E}^{2}}{{R}_{1} + h} + \frac{{v}_{N}^{2}}{{R}_{2} + h} , \qquad ( 2 )$$

where ωₑ is earth's rotation rate (˜15°/h=7.29×10⁻⁵ rad/s), v_{E} and v_{N} are east and north components of the vehicle's velocity, respectively, φ and h are vehicle latitude and ellipsoidal height, respectively, R₁ and R₂ are prime vertical and meridian radii of curvature (R˜6,378 km−WGS84 ellipsoid). 100331 In assessing the performance of the gravity disturbance estimation via the use of kinematic observables (Acceleration from the nano accelerometer and that derived from GPS positions), a distinction is made between the stochastic model of the disturbance and the estimation process itself. We model the gravity disturbance as a third-order Gauss-Markov process whose state variable representation is given as:

$$( \begin{matrix}{\dot{x}}_{1} \\ {\dot{x}}_{2} \\ {\dot{x}}_{3}\end{matrix} ) = ( \begin{matrix}0 & 1 & 0 \\ 0 & 0 & 1 \\ - {f}_{0}^{3} & - 3 {f}_{0}^{2} & - 3 {f}_{0}\end{matrix} ) ( \begin{matrix}{x}_{1} \\ {x}_{2} \\ {x}_{3}\end{matrix} ) + ( \begin{matrix}0 \\ 0 \\ w\end{matrix} ) , \qquad ( 3 )$$

or in differential equation form as:

[symbol]

+3f₀\ddot{x}+3f₀²\dot{x}+f₀³x=w, (4)

where f₀ is a process/filter bandwidth (natural frequency) [Hz]—highest frequency at which signal can be recovered (i.e. signal can be distinguished from noise) and is characterized by the relation:

$${f}_{0} = \frac{v}{b} = e . g . , \\ \frac{100}{1000} = 0.1 Hz , \qquad ( 5 )$$

where v is the vehicle velocity [e.g. 100 m/s], b is the process spatial resolution [e.g. 1000 m], and w is the driving white noise [mGal].

Moreover, Q is the power spectral density of the driving white noise [mGal2/Hz], and is characterized by the relation:

$$Q = \frac{16}{3} {s}^{2} {f}_{0}^{5} . \qquad ( 6 )$$

Gravity disturbance process generated by the driving white noise is x, while s is the gravity disturbance process standard deviation[mGal]. Thus Qₓ is the power spectral density of the gravity disturbance process x, and is characterized by the relation:

$${Q}_{x} ( ω ) = \frac{Q}{{( {ω}^{2} + {f}_{0}^{2} )}^{3}} . \qquad ( 7 )$$

The angular velocity in [rad/s] is ω=2πf. The covariance function of the gravity disturbance process x [mGal2] is Cₓ(d). The sampling distance ratio (of the process spatial resolution) is ζ=d/b, where d is the sample distance [e.g. 100 m]. Alternatively, sample time T=d/v could be used. The correlation distance [m]—distance at which Qₓ reduces to one half of the zero-lag (Qₓ) is defined as 1=2.9033b. Additionally, the output gravity disturbance signal [mGal] is defined as x₁=x. The output gravity disturbance rate signal [mGal/s] is defined as x₂=The output gravity disturbance second rate signal [mGal/s²] is defined as x₃=\ddot{x}.

Both the navigation state vector and the instrument error state vector of the navigation solution are augmented with the gravity disturbance states. As seen from the equations above, position (φ, h) and velocity (v_{E}, v_{N}) errors affect the computation of the disturbance. Optimal estimates of the error states are obtained through a Kalman filter process. In the Kalman filter setup, the differences between the inertial navigation solution and the GPS positions and velocities are used as updates.

Because the gravity disturbance is not observable in this setup, the Kalman design matrix coefficients for the disturbance states are set to zero. This means the a posteriori covariance estimates of the gravity disturbance and its rates are not affected by the update measurements. The estimates of the gravity disturbance itself, however, are affected by the measurements, since the filter gain values associated with these terms are nonzero. The gravity disturbance estimates benefit from the measurement updates, but their covariance does not, instead evolving solely according to the error model. In other words, the covariance does not reflect the correct confidence in the gravity disturbance state, unless the model used is representative of the actual phenomenon.

To simulate this phenomenon, synthetic positions and velocities representing those obtainable through GPS were generated, along with synthetic angular rate and specific force measurements obtainable from an IMU. The INS mechanization was run in the MATLAB environment along with a Kalman filter stage for incorporating the synthetic GPS measurement updates. Noise values for positions varied from 1 mm to 1 m, representing the positional uncertainty of the platform at any given time. Gyro and accelerometer noise was modeled using the power spectral density (PSD) information available from the IMU used. For convenience, the platform was simulated to be moving from a position of 0° N, 85° W directly West at a velocity of 100 m/s with 0° roll and pitch and 270° heading. The gravity spatial resolution was fixed at 1000 m.

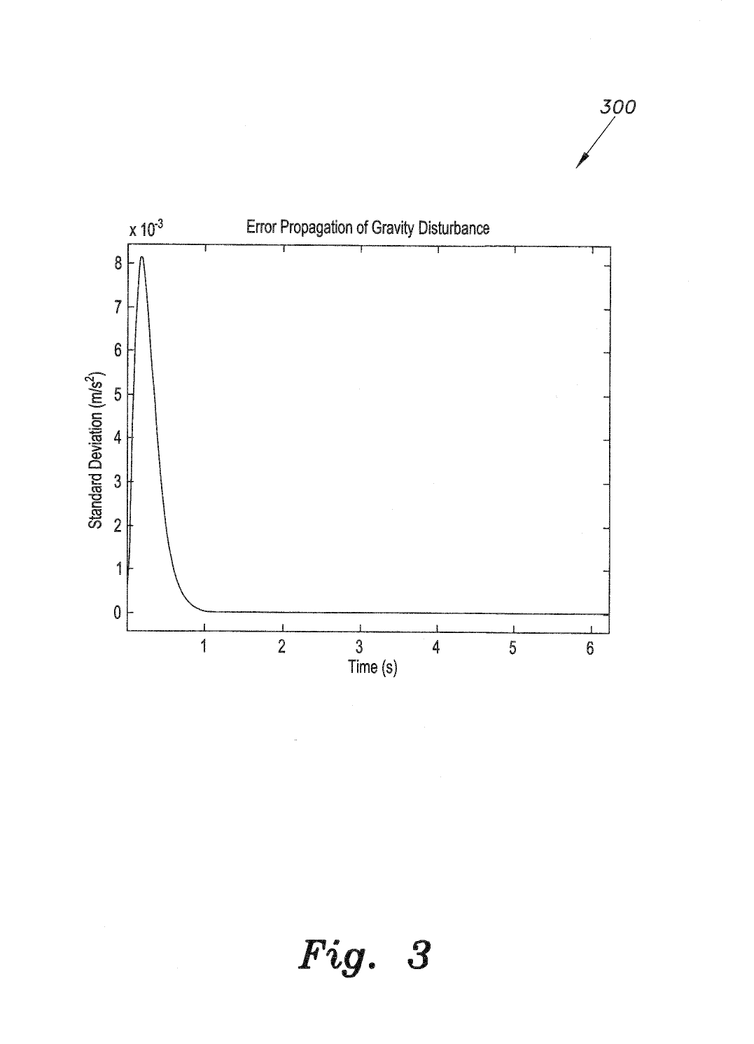

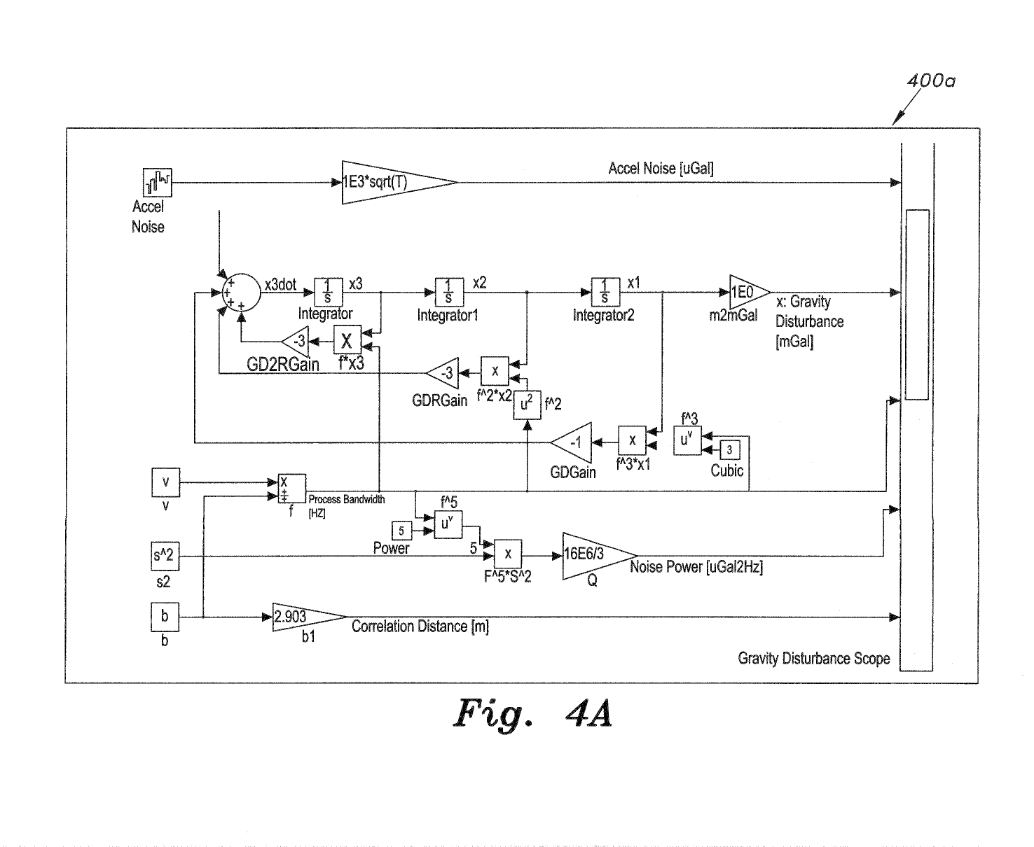

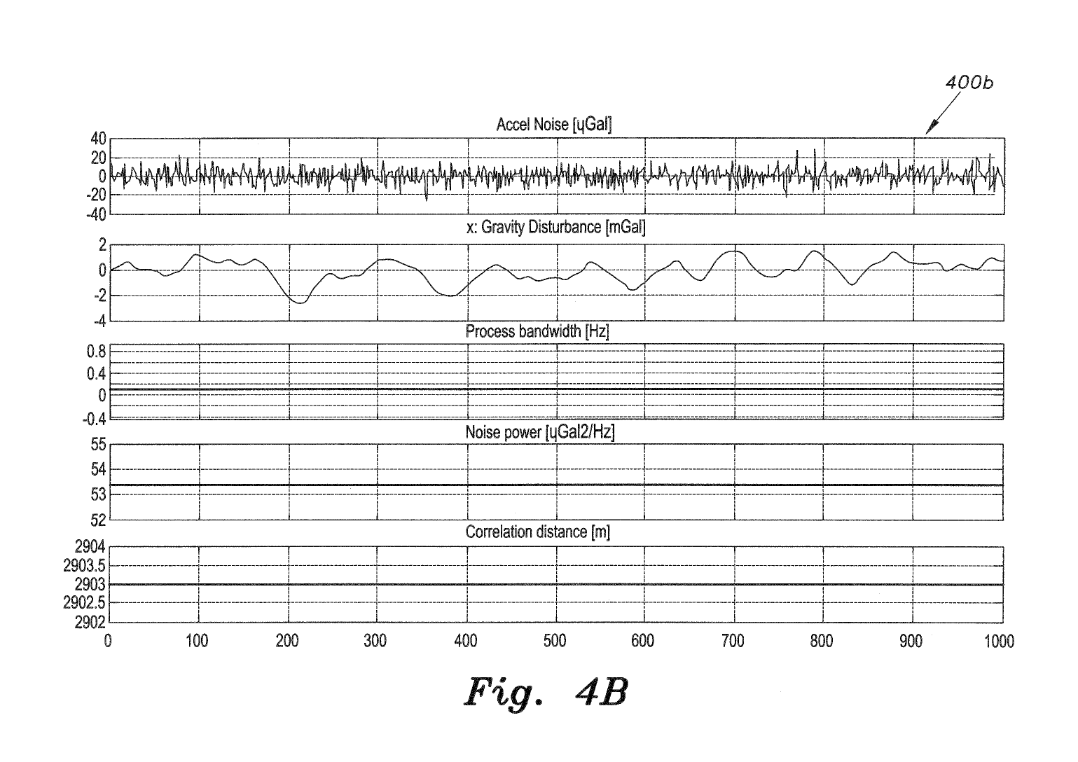

Plot 300 of FIG. 3 shows the Kalman filter evolution of the gravity disturbance standard deviation. As expected, after a transitional stage, the standard deviation reaches its lowest value at steady state (1×10⁻⁵ m/s²˜1 mGal). The first and second disturbance rates follow similarly, but at much smaller scales. The third-order Gauss-Markov model simulation 400a, which includes the Kalman filter, was built as outlined in the block diagram of FIG. 4A. It should be understood by one of ordinary skill in the art that implementation of the Gauss-Markov model/Kalman filter 400a can comprise software or firmware code executing on a computer, a microcontroller, a microprocessor, or a DSP processor, state machines implemented in application specific or programmable logic, or numerous other forms. Computational processes implementing the system can be provided as a computer program, which includes a non-transitory machine-readable medium having stored thereon instructions that can be used to program a computer (or other electronic devices) to perform the processes. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

The simulation results are shown in plot 4003b of FIG. 4B. A value between +/−2 mGal gravity disturbance can be recovered from accelerometer noise of +/−20 μGal (20 nano-g) at spatial resolution of 1000 m. The nano accelerometer used in Gray-Map provides such a low noise.

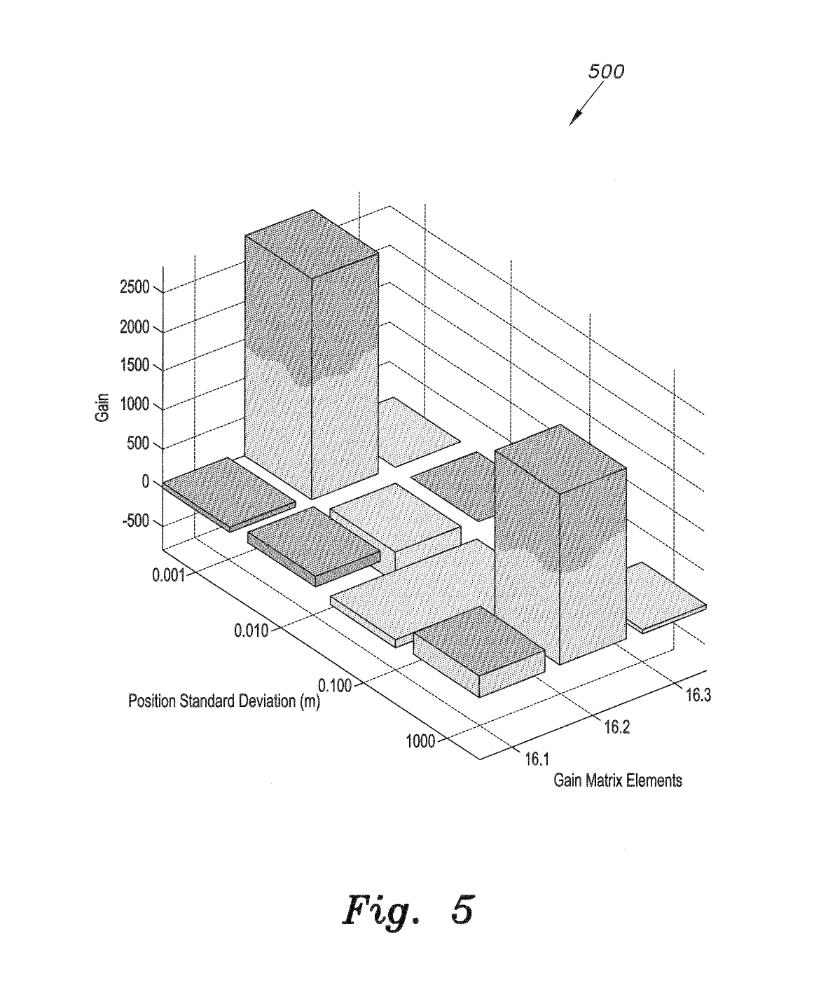

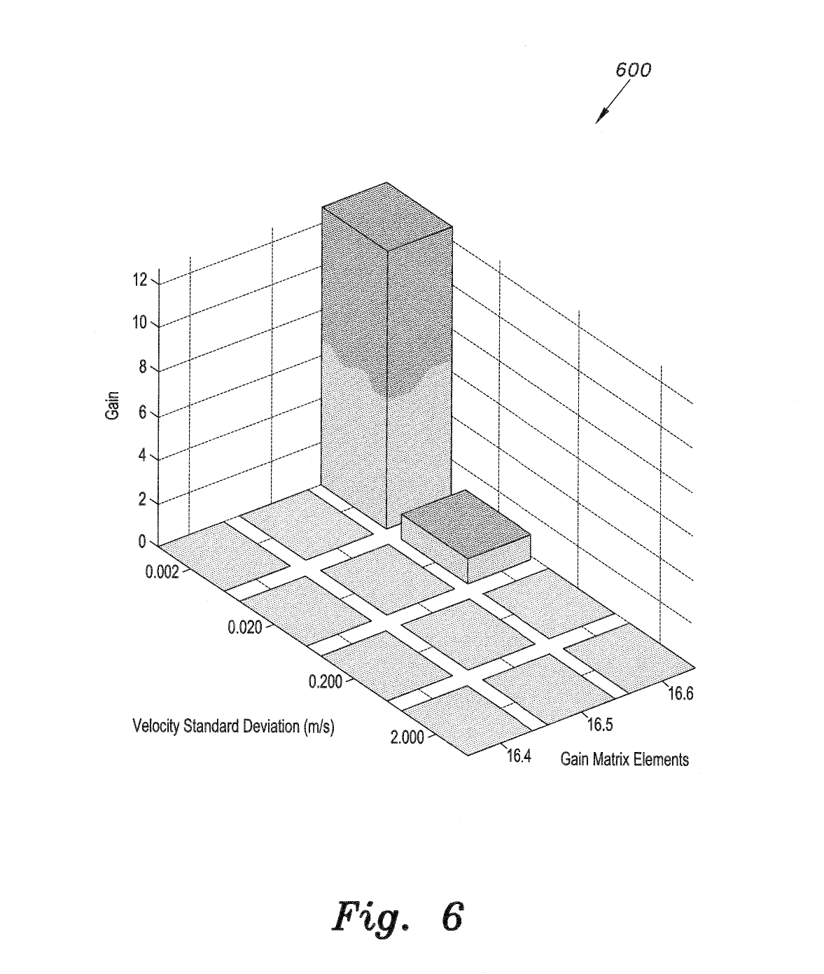

Apart from the covariance and simulation analyses, it is also instructive to examine the steady-state gain values of the disturbance state computed from the Kalman filter, and in particular, the gain terms mapping the positional and velocity errors to the disturbance state, which show the contribution of the updates to the state estimates. The elements of the gravity disturbance row (row 16) of the gain matrix are presented in graphs 500 and 600 of FIGS. 5 and 6, one for the position update, the second for the velocity update. (1&4), (2&5), and (3&6) represent East, North, and Up channels, respectively. The greatest effects (high columns) are seen due to positional errors, but with no clear trend as a function of positional accuracy. This may be due to coupling with excessive accelerometer noise, as it is expected that gain would decrease with decreasing GPS positional accuracy. It is clear from graph 500 of FIG. 5, however, that errors in height do not contribute as much as errors in latitude and longitude. With respect to the velocity errors (FIG. 6), decrease in gain is observed as a function of increasing velocity error. Furthermore, the up velocity error is the major contributor.

A conclusion to be drawn from the graph data 500 and 600 of FIGS. 5 and 6 is that provided the third-order Gauss-Markov model is an accurate representation of the gravity disturbance process, its inclusion in the Kalman filter can lead to improvements in the navigation parameters, which, in turn, can lead to better estimates of the disturbance when incorporated with GPS update measurements. The drawback, however, is that there is no improvement to the covariance of the disturbance states through this method, as the model is purely stochastic and the parameters themselves are not observable. A combination of a deterministic scalar model and this stochastic modeling would overcome the shortcoming. Field tests should make for better understanding of the whole process.

It is to be understood that the present invention is not limited to the embodiments described above, but encompasses any and all embodiments within the scope of the following claims.

We claim:

1. An inertial system for gravity difference measurement, comprising:
a global navigation satellite system (GNSS) receiver; and
a strapdown inertial measurement unit (IMU) connected to the GNSS receiver, the IMU having means for performing stochastic modeling of a gravity anomaly whereby relative changes between points as opposed to absolute values at the points allow for high relative precision, the system being adapted for use on an airborne platform to measure differences in the earth's gravitational field.

2. An inertial system for gravity difference measurement, comprising:
a computer;
a Global Navigation Satellite System (GNSS) receiver connected to the computer to allow GNSS data flow and synchronization between the GNSS receiver and the computer for acquisition of GNSS data by the computer;
an Inertial Measurement Unit (IMU) connected to the computer to allow data flow between the IMU and the computer for acquisition of IMU data by the computer, the IMU also having an IMU synchronization signal path to the GNSS;
a nano accelerometer connected to the computer to allow data flow between the nano accelerometer and the computer for acquisition of nano accelerometer data by the computer;
means for powering the computer, GNSS receiver, IMU and accelerometers;
means for storing data generated by the computer when processing the GNSS, IMU, and accelerometer data flows; and
means for performing stochastic modeling of a gravity anomaly wherein relative changes between points as opposed to absolute values at the points allow for high relative precision.

3. The inertial system for gravity difference measurement according to claim 2, wherein said IMU and said nano accelerometer are housed in an enclosure separate from an enclosure housing the computer and GNSS receiver.

4. The inertial system for gravity difference measurement according to claim 3, further comprising a communal cable connecting the IMU and the nano accelerometer to the computer.

5. The inertial system for gravity difference measurement according to claim 4, wherein the IMU is a commercial-off-the-shelf (COTS) strapdown IMU.

6. The inertial system for gravity difference measurement according to claim 2, wherein said GNSS receiver is configured for outputting GNSS L1 and L2 range measurements and navigation data from satellites in both Global Positioning System (GPS) and GLObal NAvigation Satellite System (GLONASS) systems.

7. The inertial system for gravity difference measurement according to claim 2, further comprising means for generating timestamps for data acquired from the GNSS receiver.

8. The inertial system for gravity difference measurement according to claim 7, further comprising means for generating timestamps for data of the IMU.

9. The inertial system for gravity difference measurement according to claim 8, further comprising:
means for indicating how many GPS satellites are being tracked; and
means for indicating how many GNSS satellites are being tracked.

10. The inertial system for gravity difference measurement according to claim 8, wherein the IMU comprises:
three gyros contributing to the IMU data flow;
three accelerometers contributing to the IMU data flow;
three magnetometers contributing to the IMU data flow; and
one temperature sensor contributing to the IMU data flow.

11. The inertial system for gravity difference measurement according to claim 8, wherein the nano accelerometer is a three-axis accelerometer with ultra-low noise in order to detect the anomaly of gravity signal at the level of micro-G.

12. The inertial system for gravity difference measurement according to claim 11, further comprising means for timestamping data from the nano accelerometer with computer time for further synchronization in post-processing of the nano accelerometer data.

13. The inertial system for gravity difference measurement according to claim 12, further comprising means for converting the data acquired by the computer to readable format.

14. The inertial system for gravity difference measurement according to claim 13, further comprising:
means for converting binary Radio Technical Commission (RTCM)-3 data to standard Receiver Independent Exchange (RINEX) format;
means for converting binary IMU data to TEXT file with pulsing information;
means for extracting IMU pulsing information in GNSS receiver time from binary GNSS receiver data; and
means for time-stamping IMU data with GNSS receiver time.

15. An inertial system for gravity difference measurement, comprising:
a computer;
a Global Navigation Satellite System (GNSS) receiver connected to the computer to allow GNSS data flow and synchronization between the GNSS receiver and the computer for acquisition of GNSS data by the computer;
an Inertial Measurement Unit (IMU) connected to the computer to allow data flow between the IMU and the computer for acquisition of IMU data by the computer, the IMU also having an IMU synchronization signal path to the GNSS;
a nano accelerometer connected to the computer to allow data flow between the nano accelerometer and the computer for acquisition of nano accelerometer data by the computer;
means for powering the computer, the GNSS receiver, the IMU and accelerometers;
means for storing data generated by the computer when processing the GNSS, IMU, and accelerometer data flows; and
means for recovering a gravity disturbance signal from a combination of the accelerometer data, the GNSS data, and the IMU data.

16. The inertial system for gravity difference measurement according to claim 15, further comprising means for computing a basic model used in the inertial system for gravity difference measurement, the basic model being characterized by the relation:
δg=fᵤ−aᵤ+E_{c}−γᵤ,
where δg is the upward component of the gravity disturbance, measured in mGal (milli Galileo) where 1 mGal˜1 μg=10⁻⁵ m/s² and g is the average Earth's gravity acceleration (˜9.81 m/s²), fᵤ is the upward component of the specific force, measured by the accelerometer, aᵤ is the upward component of the vehicle acceleration, derived from measured GPS position, γᵤ is the upward component of the normal gravity vector at vehicle height, computed analytically using normal ellipsoidal model (e.g. WGS84), and E_{c} is the to Eötvös correction due to Coriolis and centrifugal accelerations in the horizontal plane resulting from the relative motion of the vehicle with respect to the rotating Earth.

17. The inertial system for gravity difference measurement according to claim 16, further comprising means for computing the Eötvös correction, wherein said Eötvös correction is characterized by the relation:
$${E}_{c} = 2 {v}_{E} {ω}_{e} cos ϕ + \frac{{v}_{E}^{2}}{{R}_{1} + h} + \frac{{v}_{N}^{2}}{{R}_{2} + h} ,$$
where ωₑ is earth's rotation rate (˜15°/h=7.29×10⁻⁵ rad/s), v_{E} and v_{N} are east and north components of the vehicle's velocity, respectively, φ and h are vehicle latitude and ellipsoidal height, respectively, R₁ and R₂ are prime vertical and meridian radii of curvature (R˜6,378 km−WGS84 ellipsoid).

18. The inertial system for gravity difference measurement according to claim 16, further comprising means for computing the gravity disturbance as a third-order Gauss-Markov process having a state variable representation characterized by the relation:
$$( \begin{matrix}{\dot{x}}_{1} \\ {\dot{x}}_{2} \\ {\dot{x}}_{3}\end{matrix} ) = ( \begin{matrix}0 & 1 & 0 \\ 0 & 0 & 1 \\ - {f}_{0}^{3} & - 3 {f}_{0}^{2} & - 3 {f}_{0}\end{matrix} ) ( \begin{matrix}{x}_{1} \\ {x}_{2} \\ {x}_{3}\end{matrix} ) + ( \begin{matrix}0 \\ 0 \\ w\end{matrix} ) ,$$
and a differential equation form characterized by the relation: [symbol]
+3f₀\ddot{x}+3f₀²\dot{x}+f₀³x=w,
where f₀ is a process/filter bandwidth (natural frequency) [Hz]—highest frequency at which the gravity disturbance signal can be recovered, w is a driving white noise [mGal], x₁ is an output gravity disturbance signal [mGal], x₂ is an output gravity disturbance rate signal [mGal/s], and x₃ is an output gravity disturbance second rate signal [mGal/s²].

19. The inertial system for gravity difference measurement according to claim 18, further comprising a Kalman filter in operable communication with the third-order Gauss-Markov process, the Kalman filter providing optimal estimates of error states of the gravity disturbance computation.
